(19) United States
(12) Patent Application Publication
(10) Pub. No.: US 2008/0225833 A1
(43) Pub. Date: Sep. 18, 2008

(54) Apparatus For Guaranteeing the Availability of Subscribers in Communication Networks Over Network Boundaries

(75) Inventor: Norbert Lobig, Darmstadt (DE)

Correspondence Address: BELL, BOYD & LLOYD, LLP, P.O. BOX 1135, CHICAGO, IL, 60690, US

(73) Assignee: Nokia Siemens Networks GmbH & Co. KG, Munchen (DE)

(21) Appl. No.: 11/996,923

(22) PCT Filed: Jul. 6, 2006
(86) PCT No.: PCT/EP06/63972

§ 371 Date: Jan. 25, 2008

(30) Foreign Application Priority Data
Jul. 26, 2005 (DE) 10 2005 034 874.2

(51) Int. Cl. H04L 12/66; H04L 12/16

(52) U.S. Cl. 370/352; 370/259; 340/14.69

(57) ABSTRACT

According to prior art, for example, when danger or environmental catastrophe are imminent, the population is warned by information guided via the communication network. This type of warning is however limited when the communication network consists of a plurality of sub-networks and the (warning) information must thus be transmitted over network boundaries to the subscriber The invention solves this problem in that a warning profile is associated with each route/transit switching centre trunk group. The association is carried out during the establishment of the route/transit switching centre trunk group, and is updated as required as changes of the network configuration. Each network transition implicitly thus has one such warning profile.

### CLAIM FOR PRIORITY

This application is a national stage of PCT/EP2006/063972, filed Jul. 6, 2006, which claims the benefit of priority to DE 10 2005 034 874.2, filed on Jul. 26, 2005, the contents of which are hereby incorporated by reference.

### TECHNICAL FIELD OF THE INVENTION

The invention relates to an apparatus for ensuring the availability of subscribers in communication networks over network boundaries.

### BACKGROUND OF THE INVENTION

In the prior art, populations are alerted/warned of relatively great danger or environmental catastrophes such as fire, storms, floods, effects of accidents, war clashes etc. by means of sirens. The population is notified about the immediate and imminent threats by means of sounds/tone sequences. However, siren alerting does not provide universal coverage, and even where it is provided, such as in large cities, not everyone can be reached, depending on their location. Since, sounds/tone sequences are available only to a limited degree, and there is no guarantee that the population is aware of them, it is possible to see that this type of alerting/warning of the population is subject to tight limits.

The same applies to alerting/warning by radio and television, since these media assume that the respective medium is being used at the time of the warning. However, the broad multiregional range of programs (i.e. the subscribers have not switched on the relevant local channel on which the warning is currently being received) means that not even this case ensures that the alert/warning actually arrives.

Admittedly, the operators of the telecommunication networks have developed alternatives based on communication networks in order to solve this problem. These involve proposals based on broadcast of announcements. However, these also leave it uncertain as to whether the alert/warning has actually reached the respective addressee, has been received by him and has been understood. Thus, by way of example, pure announcement services have the problem that the subscriber has activated certain call-processing features at the particular time at which the alert is sent. Hence, putting through the connection is not a criterion for the announcement having actually been received, however.

In the case of the broadcast solution, the local exchanges are addressed via their user interface and prompted to broadcast the information when required. However, this approach is based on the assumption of a single local network operator whose local exchange terminates all the lines in a certain region and covers the region with appropriate local area codes (LAC), which is no longer quite true. Subscribers on the other side of network boundaries for private networks (e.g. company networks) or competing public networks are reached only if the same broadcast functionality and accordingly simultaneous user actions are implemented in these networks. However, this cannot be assumed for the multiplicity of, in particular, private networks of greatly differing size.

One problem with such an approach is that subscribers on the other side of network boundaries for private networks are not known to the peripherally located local exchanges and are therefore ignored in respect of announcement services for warning the population. In the case of private extensions, the central (service) number (head number, operator number) can be notified but not all or a subpopulation of the subscribers connected in the private network. Subscribers on the other side of network boundaries for public networks are likewise unknown to the peripherally located trunk or local exchanges for a given network and are therefore likewise ignored in respect of announcement services for warning the population in this network. Unlike in the case of private extensions, it is not even possible to resort to a (service) number for representative information in this instance.

Another problem is that even when the subscribers to be notified behind a network boundary are known, the peripherally located switching network is unsuitable for rapid information on account of the usually small bandwidths at network gateways.

The disadvantage based on this prior art is that assistants cannot actually assume that the alert/warning for subscribers in neighboring networks has actually arrived with the addressees and has actually been noted. This would be imperative, however, in order to be able to take supporting measures on a specific basis, which ultimately results in damage being avoided and lives being able to be saved.

### SUMMARY OF THE INVENTION

The invention demonstrates a way in which it is possible to guarantee the availability of as many people as possible in neighboring networks in order to be able to inform and communicate efficiently when needed.

Advantages of the invention include, for example, assigning alert profiles to each intermediate switch cluster (trunk group) when routes/trunk groups are set up means that each network gateway implicitly has an alert profile. As a result, it is not even necessary for each network to have a user interface for informing connected subscribers. In addition, the user interfaces do not need to be opened for access by superordinate population warning systems, and subscriber data, the configuration of the network and availability information do not need to be known over network boundaries.

The inventive method is independent of the network technology (TDM, IP).

Furthermore, existing switching nodes can be used with moderate functional changes, which means that investments already made by the network operator are safeguarded and expansion by the inventive functionality means only small additional investment and risk.

Finally, economic use of the call-processing resources is possible, since particularly the network gateways and intermediate switch clusters are not additionally used by the inventive method and no expansions in this regard need to be made.

In principle, short prewarning times/alerting times are possible, since the warning is given in decentralized fashion by the switching nodes in question and using current announcements.

### BRIEF DESCRIPTION OF THE DRAWINGS

The invention is explained in more detail below using an exemplary embodiment which is shown in the figures, in which:

FIG. 1 shows a network configuration, comprising three networks.

FIG. 2 shows the playing of a warning to subscribers in two IP-based networks.

FIG. 3 shows the playing of a warning to video telephony subscribers.

### DETAILED DESCRIPTION OF THE INVENTION

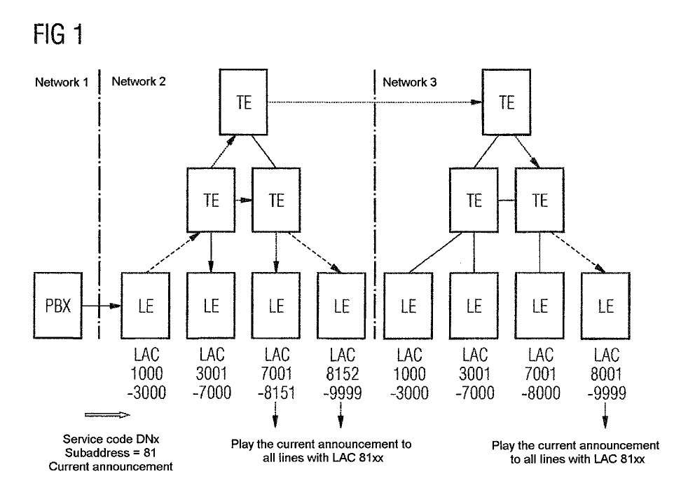

FIG. 1 shows a network configuration with 3 (sub)networks. The networks are formed from local exchanges LE and transit exchanges TE. The exchanges are interconnected by means of intermediate switch clusters.

Each intermediate switch cluster (trunk group) is provided with an alert profile which is created when the route/trunk group is set up and, when needed, is updated in the course of changes to the network configuration. Implicitly, this means that each network gateway also has an alert profile of this kind.

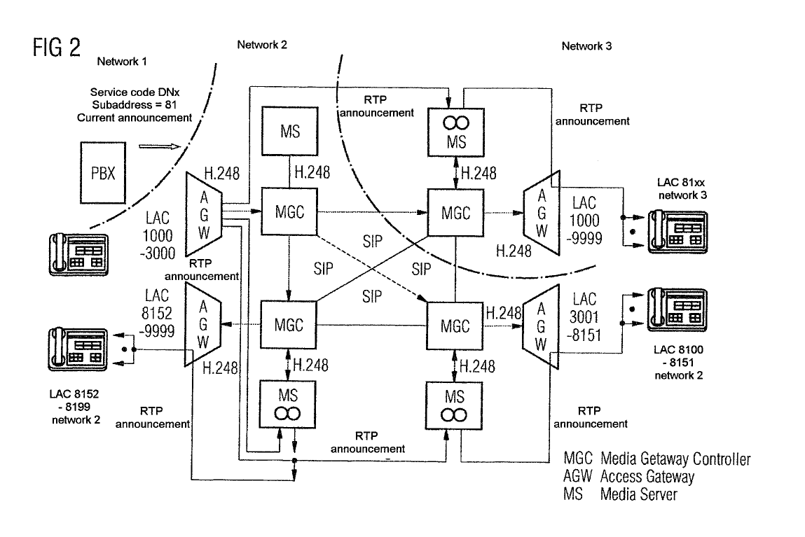

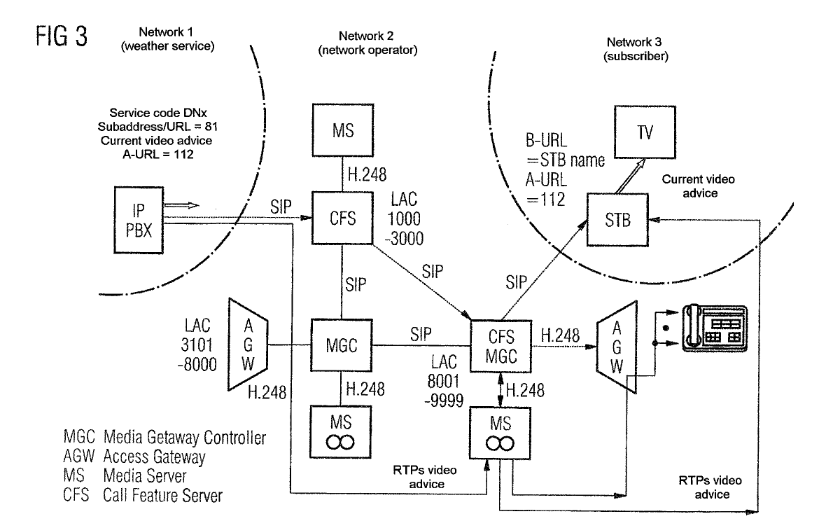

Part of the alert profile may be a set of telephone numbers, a set of circuit identification codes (CIC) (in the case of ISUP-based TDM network gateways), a set of ISDN channels on a PRI/BA or analog lines (in the case of same-subscriber network gateways from the public network and network gateways to private networks), a set of physical or symbolic destination address identifiers for a network gateway (in IP-based networks), a set of port numbers for a network gateway determined by physical or symbolic destination address identifiers in IP-based networks. None of the statements made above in respect of packet-based networks apply to FIG. 1, they are relevant to FIGS. 2 and 3.

The alert profile is set up consistently in the two exchanges terminating an intermediate switch cluster. In the case of IP-based networks, the intermediate switch cluster can be reduced to a communication relationship between two call controllers, in which case appropriate profile information can be stored for information services for warning the population and the communication relationship can be represented by the packet address of the remote node, a real or virtual point code, virtual intermediate switch clusters or the like. Again, the statement made above in respect of packet-based networks does not apply to FIG. 1, it is relevant to FIGS. 2 and 3.

If the profile is not set (default setting), the intermediate switch cluster is also not considered within the context of a warning to the population. In particular, the warning to the population is not transmitted via the cluster in question or the playing signaled to the associated remote call controller.

In an exchange which is active for warning the population, subsequently called source exchange for short, the alert profile characterizes whether and in what way a warning to the population is to be forwarded via the intermediate switch cluster. In an exchange which is not yet active for warning the population, subsequently called destination exchange for short, the profile characterizes whether and in what way a warning to the population can arrive and be identified as such via the intermediate switch cluster.

The profile information from an intermediate switch cluster may be defined on the basis of time. This means that, by way of example, it may not be set during the day whereas at night warnings to the population are intended to be forwarded via these clusters.

The intermediate switch clusters described above may be defined between public exchanges or on the interface between public and private exchanges.

For each intermediate switch cluster with a set profile, the source exchange sets up a connection in line with the prompts in the alert profile, that is to say puts on an appropriate telephone number or destination address, possibly selects for this one of the required channels or a packet address/port number provided for this purpose and plays the warning to the population over the intermediate switch cluster. In this context, the warning to the population may be stored in an internal or external appliance controlled by this exchange, or, after the destinations have been put through, it is first sent from a peripherally arranged intermediate switch cluster or a subscriber device, is directly replicated without buffer-storage and is transmitted further in the direction of the destinations.

A destination exchange uses suitable internal service logic to trigger upon the arrival of a warning to the population on all intermediate switch clusters or channels provided for this purpose in line with the alert profile. Triggers for this may be the use of the special destination telephone number or else a special A telephone number, a line, an IP address, a port number or else receipt of a special signaling message content (e.g. a message ID).

Depending on the type and number of subscribers to be informed by the destination exchange and on the basis of the alert profiles of intermediate switch clusters on downstream switching nodes which are to be informed, the warning to the population can in this case be recorded and buffer-stored in an internal or external appliance controlled by this exchange. Alternatively, when the destinations have been put through, it can first be transmitted via the reception-end intermediate switch cluster and can be directly replicated without buffer-storage and transmitted further in the direction of the destinations.

The source exchange ensures that said lines, telephone numbers cannot be reached by chance by a natural user of the network and that the signaling criterion can be set. This is done to protect against unintentional activation and misuse of the function.

Within the meaning of the definition above, trunk exchanges may be either a source exchange or a destination exchange. They have likewise defined the alert profile described above for each route/trunk group. They generate a call having the properties required in the profile if profile information is defined for the respective trunk group and the trunk group is, in particular, a network gateway or else is the connection to another exchange in its own network which looks after the alert area to be reached or else provides support for the route thereto. If the call is taken by the remote end, the announcement possibly stored in the media server/intelligent peripheral or an announcement derived therefrom for warning the population is played.

For the purpose of buffer storage and for the purpose of output when required, a media server or an intelligent peripheral may be used. These units record the transmitted warning to the population and keep it ready for further editing. The information recorded in a media server/intelligent peripheral is optionally automatically checked for associated signaling information and content (e.g. voice recognition). Specifics of the alerting which are not signaled or cannot be signaled outband can therefore be detected inband by means of keyword recognition.

The alert area in question may be signaled, e.g. using the A telephone number or the subaddress, and may be given in the form of a local area code (LAC) . Alternatively, it can be established by means of voice recognition. Accordingly, an information message which is relevant to the addressed network, possibly new, is formed and the extent of alerting is determined. This produces the intermediate switch clusters and subscriber bodies to be informed downstream. In particular, this covers network gateways to public and private networks.

A local exchange which is supplied with a warning to the population via a signaled connection transfers said warning economically and without network blocking to the subscriber population in question, preferably with buffer storage and the use of broadcast technology. Each destination exchange has mechanisms available for identifying warnings to the population with the same content which arrive via different intermediate switch clusters. By way of example, this is done by defining guard times and/or evaluating the announcement text.

The source and destination exchanges optionally write tickets (CDR, Call Data Records) for each incoming and outgoing warning call to the population. These can be used for billing to the subscribers and the connected further network operators or the stations initiating the warning to the population.

If an intermediate switch cluster or the intermediate switch cluster's channels to be used for warning the population is/are fully occupied then the source exchange can initiate rejection of connections in order to obtain the capacity for putting through the warning to the population, or time monitoring can be started which is linked to the buffer storage of the incoming warning announcement.

The method can likewise be used in the IP environment (see FIG. 2). In this case, the warning to the population may be in the form of a video announcement/multimedia advice. The indicated method can easily be used to initiate a warning to the population by an authorized subscriber, e.g. a catastrophe prevention office, using its call-processing interface on its private branch exchange. The announcement text is therefore up to date as desired. Complicated inputs on the user interfaces of a plurality of switching nodes which are involved are superfluous. It is not necessary to influence a central alerting system for generating appropriate inputs on the user interfaces of the switching nodes. All competing networks are covered by a network gateway. Decentralized use for local population advice by local authorities is possible without further measures.

If it is necessary to buffer-store or edit the announcement text, initial breaks in speech, which may be conditional upon the text being successively put through via a plurality of exchanges, are respectively eliminated before the text is played again.

If the announcement text contains any further indication of the region (e.g. town, district, borough etc.) in question, an interposed media server can identify the relevant keywords and can use a user-manageable list to ascertain the local area codes in question, which then allows a destination exchange to directly address subscribers or to forward the information via further intermediate switch clusters. Instead of the keyword method, any other form of inband signaling, such as DTMF sequences or FSK, may be used as an alternative.

The fact that a warning to the population is imminent can be signaled at the network boundary for the subscriber in the same way as at any other network boundary. This provides the subscriber terminal with the option of special and preferred treatment.

Suitable special treatment for a warning to the population by the subscriber terminal is, by way of example, the automatic acceptance of the call, switching the audio signal to the loudspeaker, switching the video signal or, in the absence thereof, a predefined content to the screen, and buffer-storing the content and repeatedly outputting it for the case of subscriber terminals in the form of a set top box or PC. With these functions, a warning to the population would interrupt the current television program received via DSL/cable/SAT, for example, and play the warning to the viewer directly on the television set.

FIG. 1 also shows the basic flow of the method in a conventional network topology on the basis of TDM-based networks. The network is formed by a plurality of local exchanges (LE) and transit exchanges (trunk exchanges TE). One of the networks has a local exchange PBX leading to it. FIG. 1 also shows the playing of a current warning to subscribers in two conventional networks with a particular LAC.

The local exchanges LE in question have means for recording and repeatedly playing back the current announcement or have controlling access to such means. The transit exchanges TE in question do not need to buffer-store the announcements by virtue of their delaying the transmission, if appropriate, until the switch to the first-mentioned means, making use of broadcast and using the signaling of the switch in the direction of the PBX to allow the announcement to be played for the first time. At this time, however, the various recording means are already engaged and possibly pick up signal which is not present and which is subsequently removed again. The alert area is defined by way of example using the leading part of the local area code LAC, which is signaled by means of the subaddress, for example, in the forward direction.

FIG. 2 shows the basic flow of the method in a modern network topology on an IP basis. In this case, the playing of a current warning to subscribers in two IP-based networks with a particular LAC is shown. This is based on the assumption that the access gateway AGW at the network boundary to network 1 is capable of supporting broadcast mode, that is to say a specific form of conferencing. If this is not the case then, as a departure from the illustration, the media server MS of the media gateway controller MGC at the network boundary to network 1 first needs to record the announcement before transmitting it further to the other media servers in parallel or sequentially and then deleting it.

Finally, FIG. 3 shows the basic flow of the method for a TV set's set top box STB suitable for video telephony. This means that a current warning to video telephony subscribers is being played via the STB.

The fact that there is a warning to the population can be identified by the set top box STB from the source address 112 (fire brigade/emergency call), for example. Such a telephone number will normally not be able to be a subscriber caller and is therefore already suitable for characterizing the warning to the population. Any other equivalent form of signaling is also admissible, however, and can be added in the CFS/MGC, if appropriate by subscriber profile. When such a call arrives with the subscriber, the STB switches the warning advice to the television set in line with the process and replaces the TV output which is in progress at the time of the warning.

If there is no video signal, the audio signal is put through while displaying a predefined still picture stored for this purpose. Any muting of the appliance is cancelled where possible in this context. If the set top box STB has means for recording, the advice is recorded and the warning to the population may be cyclically played back or receipt of the warning to the population may be indicated by audio-visual means in equivalent fashion. Operator control actions or explicit acknowledgement by the subscriber returns the box STB to normal mode.

This produces the following advantages:

Profile information for characterizing the type of further processing of warning advice on outgoing intermediate switch clusters and for identifying warning advice on incoming intermediate switch clusters is created. In addition, the distribution function is initiated from a single (sometimes private) exchange and not by centralized operator control actions on all exchanges belonging to different network operators which have subscribers connected to them.

Broadcast is used at a node for the purpose of synchronous further distribution to a few destinations, buffer-storage of the announcement text for the purpose of asynchronous and sequential information of a multiplicity of destinations. This guarantees direct and the fastest possible addressing of the destinations to be informed by the responsible public or private exchange while saving capacities on the network gateways and avoiding double administration of subscribers in a plurality of switching nodes.

Finally, the announcement text is equally as up to date as possible, contingent upon the process, as private extensions and competing public networks are covered. The alert area can be stipulated and restricted by the optional automatic identification of information which the announcement text contains.

1. An apparatus for transmitting information to a multiplicity of subscribers in at least two communication networks over the network boundaries, where each of the communication networks is formed from a plurality of exchanges which are connected to one another by means of intermediate switch clusters,
wherein each intermediate switch cluster has an associated alert profile.

2. The apparatus as claimed in claim 1,
wherein for outgoing calls on the intermediate switch cluster the profile information from the alert profile includes information for characterizing warning advice.

3. The apparatus as claimed in claim 1,
wherein for incoming calls on the intermediate switch cluster the profile information from the alert profile includes information for identifying warning advice.

4. The apparatus as claimed in claim 1, wherein an alert profile is assigned when an intermediate switch cluster is set up and/or, when needed, in the course of changes to the network configuration.

5. An apparatus for transmitting information to a multiplicity of subscribers in at least two communication networks over the network boundaries, where each of the communication networks is formed from a plurality of packet-based switching nodes which are connected to one another by means of signaling relationships, wherein each signaling relationship between two packet-based switching nodes has an associated alert profile.

6. The apparatus as claimed in claim 5,
wherein for outgoing calls to the packet-based switching nodes to be informed the profile information from the alert profile contains information for characterizing warning advice.

7. The apparatus as claimed in claim 5,
wherein for incoming calls from the packet-based switching nodes the profile information from the alert profile includes information for identifying warning advice.

8. The apparatus as claimed in claim 5, wherein an alert profile is assigned when a signaling relationship is set up and/or, when required, in the course of changes to the network configuration.

9. The apparatus as claimed in claim 5, wherein the alert profile carries at least information for a set of telephone numbers, a set of circuit identification codes, a set of useful channels on a PRI/BRI or analog lines, a set of physical or symbolic destination address identifiers or a set of port numbers on a switching node determined by physical or symbolic destination address identifiers.

10. The apparatus as claimed in claim 5, wherein service logic is provided which is arranged in at least one of the switching nodes and which identifies warning advice on the basis of the alert profile of each signaling relationship or of each intermediate switch cluster, and which optionally controls recording, evaluation, editing, buffer-storage and/or output of a piece of warning advice by at least one media server associated with the switching node or of an equivalent associated resource with appropriate functionality, and which takes the alert profile of other signaling relationships or of other intermediate switch clusters of the switching node as a basis for controlling the transfer of the optionally modified warning advice to other switching nodes in line with the prompts stored in the alert profile.

11. An apparatus for transmitting information to a plurality of subscribers in at least one communication network over network boundary toward the plurality of subscribers, the communication network is comprising:
a plurality of packet-based switching nodes which are connected to one another by signaling relationships; and
at least one subscriber terminal which has a signaling relationship with at least one of the packet-based switching nodes in the communication network, wherein
each signaling relationship between a packet-based switching node and a subscriber has an associated alert profile,
for terminating calls from the subscriber in a packet-based switching node the profile information from the alert profile includes information for characterizing warning advice on the subscriber interface,
service logic is provided in the switching node which identifies warning advice and which takes the alert profile associated with the subscriber as a basis for controlling the output of a piece of warning advice to the subscriber terminal in line with the prompts stored in the alert profile, and
the subscriber terminal identifies warning advice and its specific, prioritized and/or secure output to the subscriber.

12. The apparatus as claimed in claim 11, wherein the network boundary is configured as a network boundary to a private network.
